(19) United States
(12) Patent Application Publication
(10) Pub. No.: US 2009/0197238 A1
(43) Pub. Date: Aug. 6, 2009

(54) EDUCATIONAL CONTENT PRESENTATION SYSTEM

(75) Inventors: Christopher H. Moffatt, Sammamish, WA (US); Jay Curtis Beavers, Duvall, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/026,284

(22) Filed: Feb. 5, 2008

(51) Int. Cl. G09B 7/00

(52) U.S. Cl. 434/430

(57) ABSTRACT

An educational content presentation system and a file format for facilitating learning in that presentation system are provided. The presentation system receives an archival file, such as a ZIP file, that comprises a manifest, one or more activities, and one or more libraries. The manifest associates activities with educational content in the one or more libraries. Some or all the educational content in the library can be encrypted to facilitate digital rights management of the content or provide security in learner assessment activities. Activities can then be executed, such as by a Common Language runtime or Java virtual machine, which present the educational content in the associated libraries to facilitate student learning.

### TECHNICAL FIELD

The subject disclosure relates to a system for presenting electronic educational materials and more particularly to a system that provides educational content and behavior in a unified manner.

### BACKGROUND

Modern education is no longer limited to the traditional educational methods of the last century. In particular, education is no longer limited to a teacher lecturing to students in a classroom. Instead, the notion of education has expanded to acknowledge that learners have different learning styles and learn things at different speeds. In addition, since not all learners are able to attend a class, distance learning and e-learning provide educational opportunities that would otherwise not be available.

Consequently, a number of methods and systems for providing e-learning have been developed. Usually, these systems are Web browser-based. However, there are a number of problems with this approach. First, browser-based systems often combine content and behavior together, preventing reuse of the same behavior with other content. Secondly, instructors and third-party developers are limited to specifying behavior in scripting languages (e.g., Javascript, VBScript, ActionScript, etc.) instead of a general-purpose programming languages. In addition, most browser-based solutions lack security and digital rights management to protect the educational content or behavior from misuse by a student (e.g., cheating by a student during an assessment) or unauthorized distribution.

The above-described deficiencies of e-learning systems are merely intended to provide an overview of some of the problems of today's e-learning systems, and are not intended to be exhaustive. Other problems with the state of the art can become further apparent upon review of the description of various non-limiting embodiments that follows.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

An educational content presentation system and a file format for facilitating learning in that presentation system are provided. The presentation system receives an archival file, such as a ZIP file, that contains a manifest, one or more activities, and one or more libraries. Each activity can implement one or more behaviors, such as learner assessment, educational games, presenting educational content, etc. Each library can comprises one or more files and/or one or more streams.

The manifest provides various metadata about the content and activities in the archival file package. For example, the manifest associates activities with educational content in one or more libraries. In addition, the manifest specifies the order activities are to be performed. In one aspect, the order of activities is linear and each learner supplied the same package proceeds through the activities in the same order. However, in accordance with other aspects, the order of activities can be non-linear, such as based on the results of an initial assessment test that determines which activities are associated with weak areas for a particular learner. In addition, whether a particular activity is presented to a learner can also be dynamically determined, such as by assessment tests or based on a particular learner's learning style. The manifest can, for example, be an XML file.

In accordance with one aspect, some or all the educational content in the library can be encrypted to facilitate digital rights management of the content or provide security (e.g., for learner assessment activities). The encryption can be implemented, for example, using public key infrastructure (PKI).

Once the manifest is analyzed, activities can then be executed, such as by a Common Language runtime or Java virtual machine, which present the educational content in the associated libraries to facilitate student learning. In one aspect, the use of virtual machines facilitates executing the activities without installation and administrative privileges. Advantageously, this makes the use of the presentation system available on a wide-variety of computers where a user has limited administrative privileges, such as in computer labs of educational institutions. In addition, graphical user interfaces for an activity can be drawn using XML-based user interface descriptions (e.g., WINDOWS Presentation Foundation (WPF) or XML User Interface Language (XUL)).

In one embodiment, activities can be executed one at a time. Advantageously, this can prevent students from, for example, performing an assessment activity at the same time as an activity that teaches the student the subject matter being assessed. In addition, when activities are executed one at a time, security of DRM protected educational content can be advantageously enhanced.

In one aspect, activities can have a security barrier between them to prevent cross-activity security attacks, similar to a ‘Cross-Site Scripting’ attacks that are common in HTML content.

In one aspect, third-party developers can create activities that can be reused by instructors at numerous institutions. Since in one aspect, behaviors can be programmed in general-purpose programming languages, more developers are available that can provide full-featured behaviors compared to Web browser-based e-learning techniques. Furthermore, depending on the language implementation and digital rights, it can be possible to extend existing activities to provide additional functionality.

### BRIEF DESCRIPTION OF THE DRAWINGS

The system and methods for educational content delivery are further described with reference to the accompanying drawings in which:

FIG. 1 is a network diagram of an example environment in which electronic learning is facilitated according to one embodiment,

FIG. 2 is a block diagram of an archive file used to deliver the educational content to a student according to one aspect.

FIG. 3 is a block diagram of a manifest file according to one aspect.

FIG. 4 is an example of a manifest file according to one embodiment.

FIG. 5 is a block diagram of a library according to one aspect.

FIG. 6 is a block diagram of a presentation system application according to one embodiment.

FIG. 7 is a block diagram of the memory and hard drive of a student's computer during execution of an activity according to one embodiment.

FIG. 8 is a block diagram of an application used to create the archival file according to one embodiment.

FIG. 9 is a flowchart of a method of an educational presentation system according to one embodiment.

FIG. 10 is a flowchart of a method of executing activities to facilitate learning according to one embodiment.

FIG. 11 is a flowchart of a method of creating a file format to facilitate learning according to one aspect.

FIG. 12 is a block diagram representing an exemplary non-limiting computing system or operating environment in which the present invention can be implemented.

### DETAILED DESCRIPTION

As used herein, learning includes traditional primary, secondary, or higher education as well as workplace training and continuing professional education. Furthermore, while the disclosed subject matter is discussed as facilitating learning, one will appreciate that the disclosed subject matter can be used in other situations such as pure student assessment or software demonstrations.

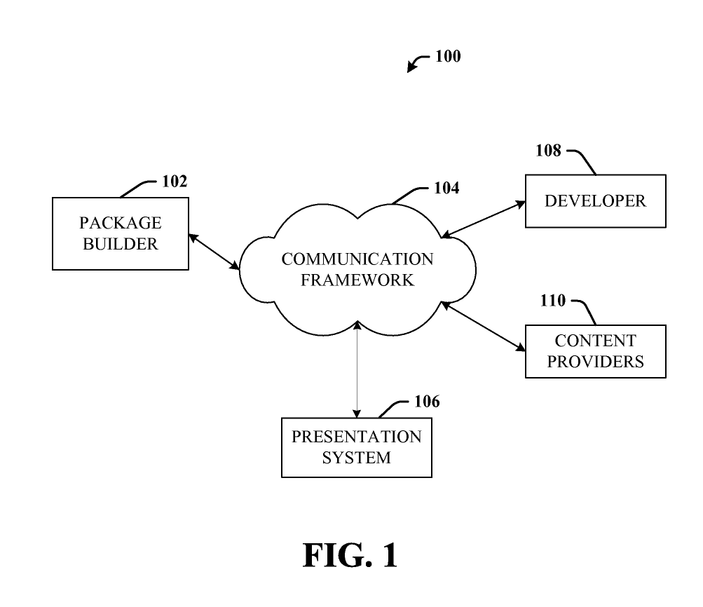

Referring to FIG. 1, a network diagram 100 of an environment in which the educational presentation system can operate. A package builder 102 can create a package that facilitates learning. In the process of creating the package, the user (e.g, a professor, teacher) of the package builder 102 can interact with third-party developers 108 to receive one or more activities and/or content provider 110 to receive content via communication framework 104. After the package is created using the package builder 102, it is transferred to a presentation system 106 via a communication framework 104. The communication framework can be a wired or wireless network, such as an educational institution network, or a storage medium, such as an optical disk or flash drive. The presentation system 106 executes activities in the package. The execution of an activity presents educational content from one or more libraries. In at least some embodiments, one or more pieces of education content (e.g., Extensible Application Markup Language (XAML), HTML) will link to remote content from content provider 110. In this scenario, the presentation system 106 can interact with content providers via the communication framework 104 to receive the linked content. Moreover, in at least some embodiments, activities are run one-at-a-time with the previous activity being unloaded before another activity is started.

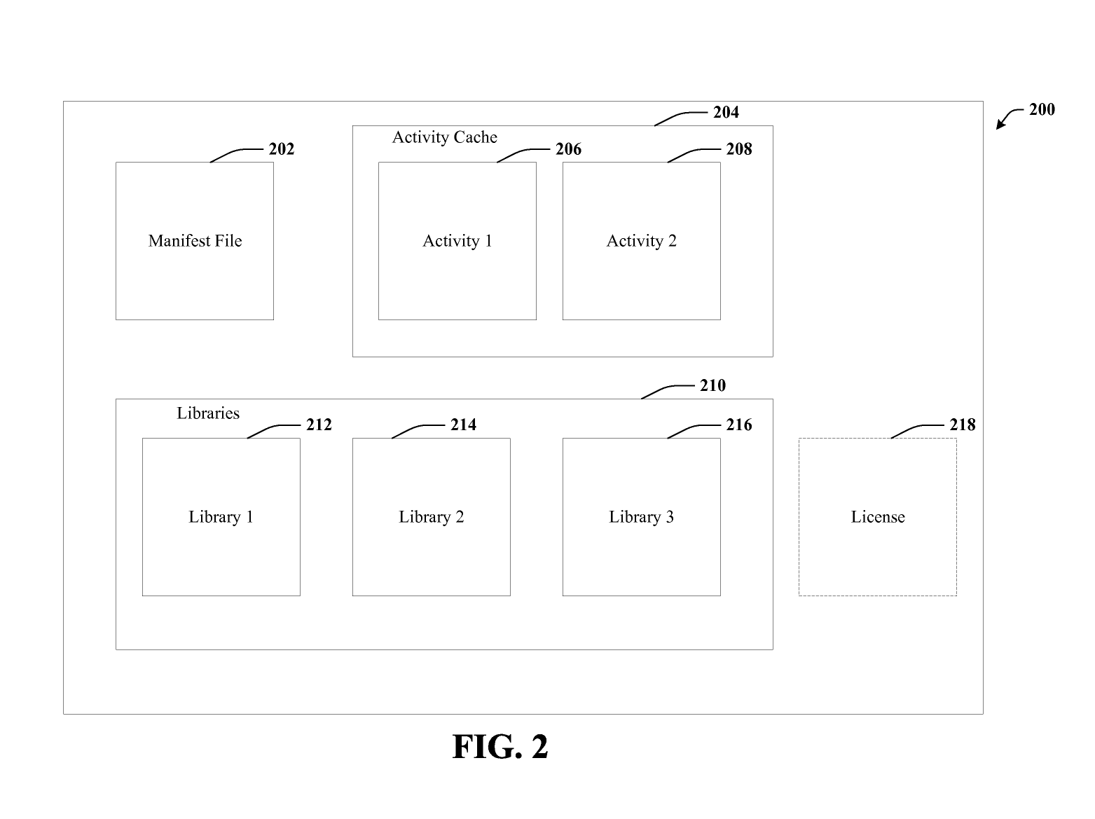

FIG. 2 is a block diagram of a file package 200 that facilitates learning according to one embodiment. In one aspect, the package is an archival file format, such as a ZIP file—although it can have a different extension that associates the file type with the educational presentation system. Although the exemplary ZIP file is a compressed archival file format, non-compressed archival file formats can also be utilized, such as a standard Unix TAR file. The package 200 comprises a manifest file 202, an activity cache 204, and one or more libraries 210. The activity cache 204 comprises one or more activities (206, 208). Each activity can implement one or more behaviors, such as student assessment, educational games, a reading passage, a video to watch, etc. Although not shown, one will appreciate that one or more activity dependencies, such as dynamic link libraries, APIs, assemblies/classes, can also e part of the activity cache 204. For example, an activity can be implemented as a Common Language Runtime assembly or a Java archive file. Advantageously, the object-oriented nature of these programming language environments facilitates extensible activities to be developed, such as through third-party developers.

The package 200 also comprises one or more libraries 210. In this illustrated example, three libraries (212, 214, 216) are shown, but one will appreciate that more or less libraries can be used in other embodiments. The libraries each comprise one or more pieces of educational content as files or streams. The libraries are associated with activities via the manifest file 202. Each activity can be associated with one or more libraries and each library can be associated with multiple activities.

In addition, the illustrated package also comprises a license file 218 that specifies digital right to at least some content of the libraries. However, one will appreciate that in at least one embodiment, a license file is not present, such as if the license is integrated into the manifest file or digital right management of content is not utilized. The license file can specify, for example, the number of times the content can be displayed, dates when the content can be displayed (e.g., to disable the content after a semester is over), whether the content can be printed or saved to disk, etc.

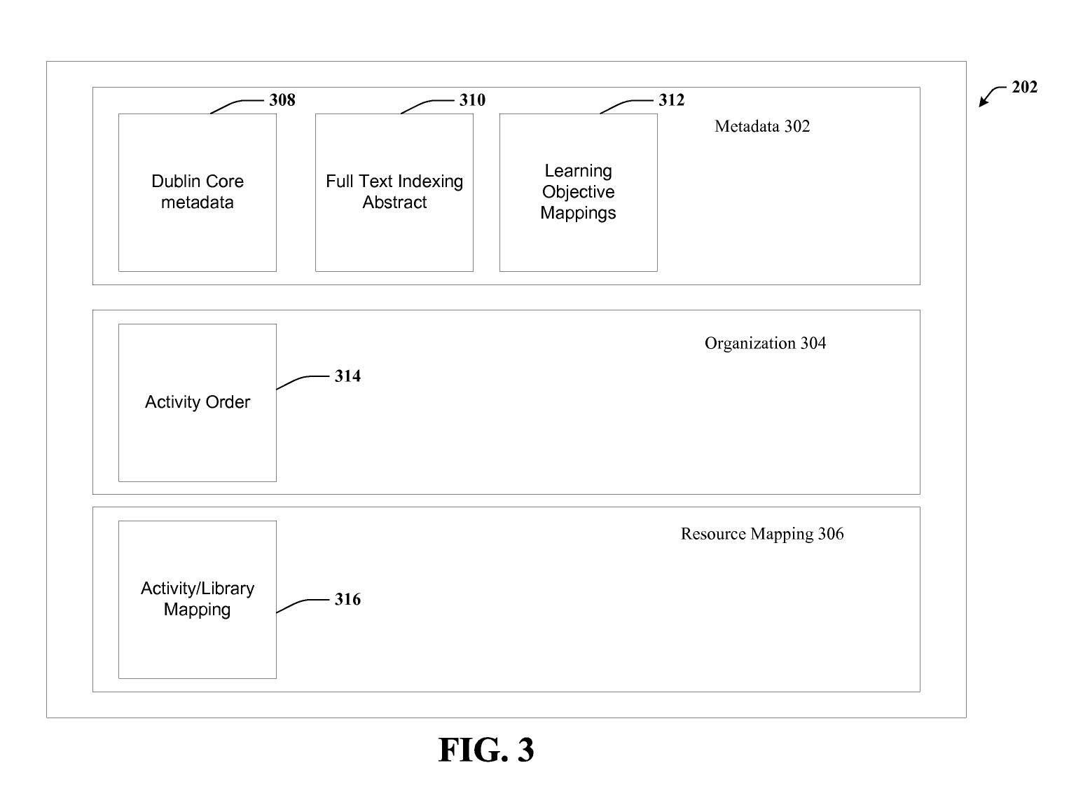

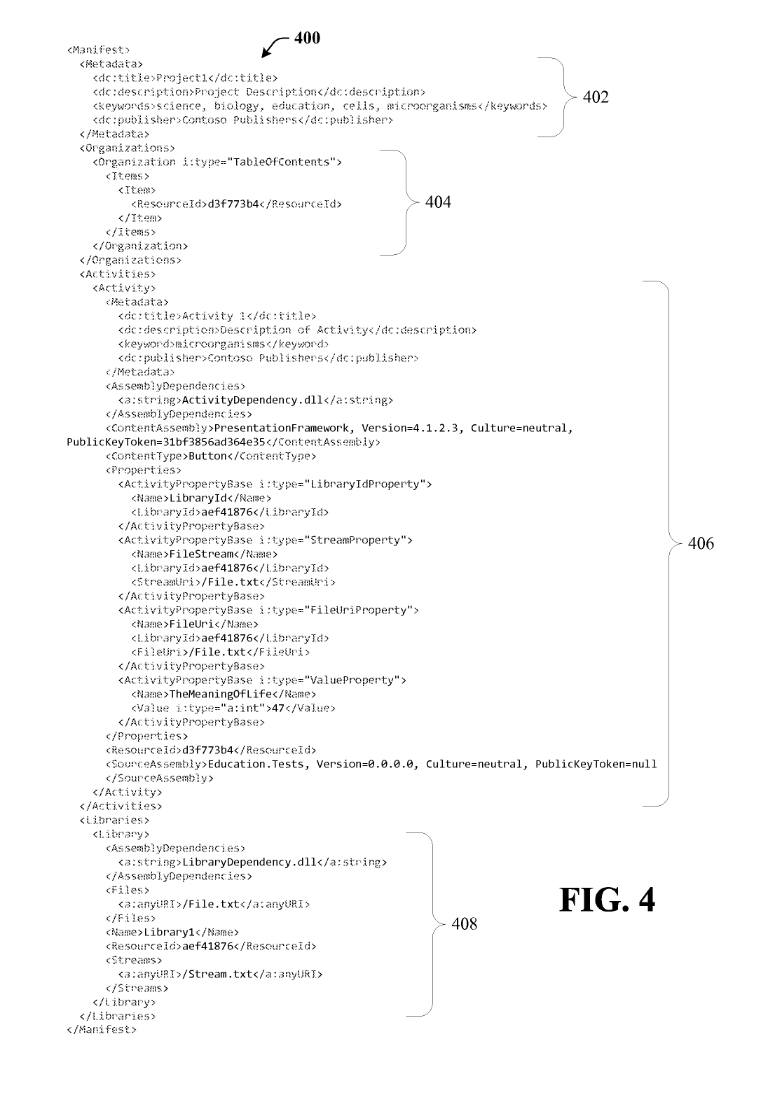

FIG. 3 is a block diagram of a manifest file 300 according to one embodiment. The manifest file comprises metadata 302, organization 304, and resource mapping 306. The metadata in the illustrated embodiment includes Dublin Core metadata 308, full text indexing abstract 310, and learning objective mapping 312. Dublin Core metadata 308 (e.g., 402 of FIG. 4) is an online metadata standard that provides a title, description, keywords, publisher, etc. The learning objective mapping 312 specifies what a learner is supposed to learn by performing the activities of the package and the objective may or may not be viewable by the learner. One will appreciate additional or fewer metadata can be present in the manifest in other embodiments. The organization 304 can specify the order of activities 314. A linear organization can be utilized such that every learner that uses the package will perform the same activities in the same order. However, according to another aspect, a non-linear activity ordering can be utilized that is conditional, such as based on the results of a learner assessment or the learner's learning style. In yet another embodiment, the learner can choose the order of the activities. The resource mapping 306 comprises an activity library mapping, which associates activities with libraries. In addition, the mapping of libraries to activities can also be specified in the metadata, such as to facilitate repacking of the package into smaller ones (e.g., a package with a subset of the activities of the current package) at a subsequent time.

FIG. 4 illustrates an exemplary manifest file 400 according to one embodiment. One will appreciate that the manifest is exemplary and other XML schemas with different element names and arguments can be utilized in other embodiments. One will also appreciate that although a XML-based manifest is illustrated. A manifest file can be implemented in other manners, such as in a specialized language or another markup language.

The illustrated manifest file 400 has an XML schema that maps to some or all of the blocks in FIG. 3. In particular, one section of Dublin Core metadata 308 is illustrated in section 402 and is part of the dc namespace in this example. The organization 304 is specified in section 404. In this example, the organization 304 is of the TableOfContents type, which provides linear progression of activities. Other types can be used as well, such as types that provide non-linear progression. Activities are associated with libraries and content in those library in section 406. Library dependencies are specified in section 408.

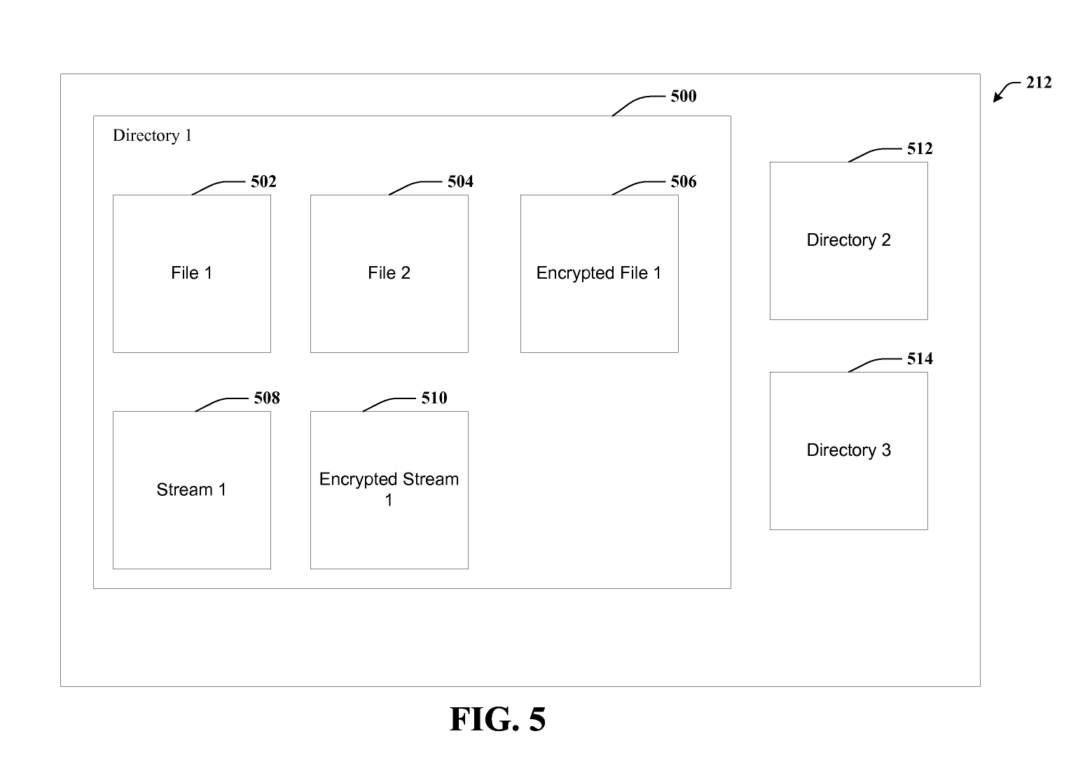

Turning to FIG. 5, a block diagram of a library 212 according to one embodiment is illustrated. The illustrated library has three directories (500, 512, 514) but one will appreciate that a library can have one or more directories. Directory 1 (500) comprises two unencrypted files 502 and 504 and one encrypted file 506. One will appreciate that other directories can have more or less files, whether encrypted or unencrypted. Each file can represent an image, text document, word processing document, presentation, XML file, etc. The files can be in various formats, including, but not limited to, HTML, PDF, XAML, XML Paper Specification (XPS), WORD documents, RTF, POWERPOINT presentation, Open Office files, TIFF, JPEG files, GIF files, PNG files, WAV files, MP3, OGG audio files, MPEG videos, and FLV videos. In addition to the files, directory 1 (500) also comprises two steams, stream 1 508 and encrypted stream 510. Streams, unlike files in some embodiments, can be accessed without decompressing/decrypting and storing the content temporally on a learner's computer.

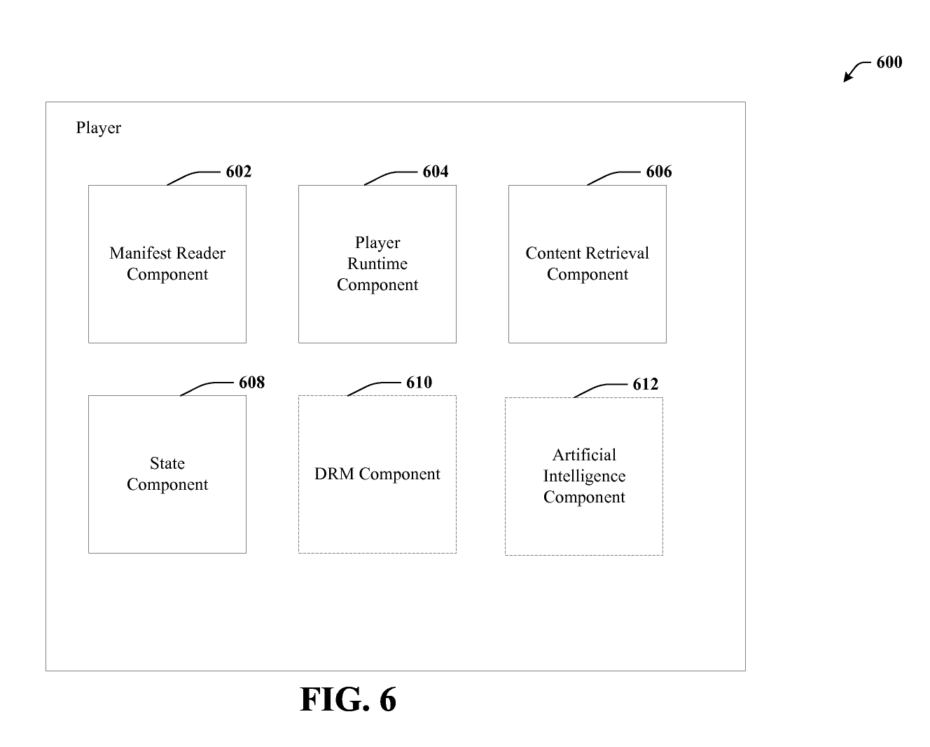

FIG. 6 illustrates a presentation application according to one embodiment. A manifest reader component 602 analyzes the manifest file to determine associations between activities and libraries. In addition, the manifest reader component 602 can also analyze the manifest file to determine the order of activities. One will appreciate that other information can be extracted and used for other purposes, such as full-text indexing.

The player runtime component 604 executes an activity. For example, in accordance with one aspect, the runtime component 604 can be a Common Language Runtime or a Java virtual machine, which executes instructions that specify one or more behaviors comprising the activity. Various APIs and standard dependencies can also be part of the player runtime component. The player runtime component 604 can in some embodiment create a user interface that a learner interacts with, such as using WINDOWS Presentation Framework (WPF) or XML User Interface Language (XUL) to specify the graphical user interface. Advantageously, developers can create extensible activities using the virtual machine and is not limited to scripting languages and security sandboxes that a browser-based electronic learning environment is subjected. In other embodiments, the player runtime component 604 comprise general-purpose media player that presents the content in the library in a specified order.

The content retrieval component 606 can retrieve files or streams from a library. For example, files can be retrieved upon loading an activity and stored in a temporary file cache. A state component 608 can keep state between activities, such as to keep track of which activities have been completed as well as various attributes (e.g., learning style, name, student ID, etc.) of the learner. The DRM component 610 can decrypt the content as needed and enforce any licensing conditions in the license 218.

In one aspect, an artificial intelligence component 612 can be used to facilitate learning. For example, the artificial intelligence component can be used by an assessment activity to determine and thus determine which activities and what order a learner should complete. As a second example, the artificial intelligence component 612 can be used to determine a learner's learning style and thus choose activities to match that learning style, if available.

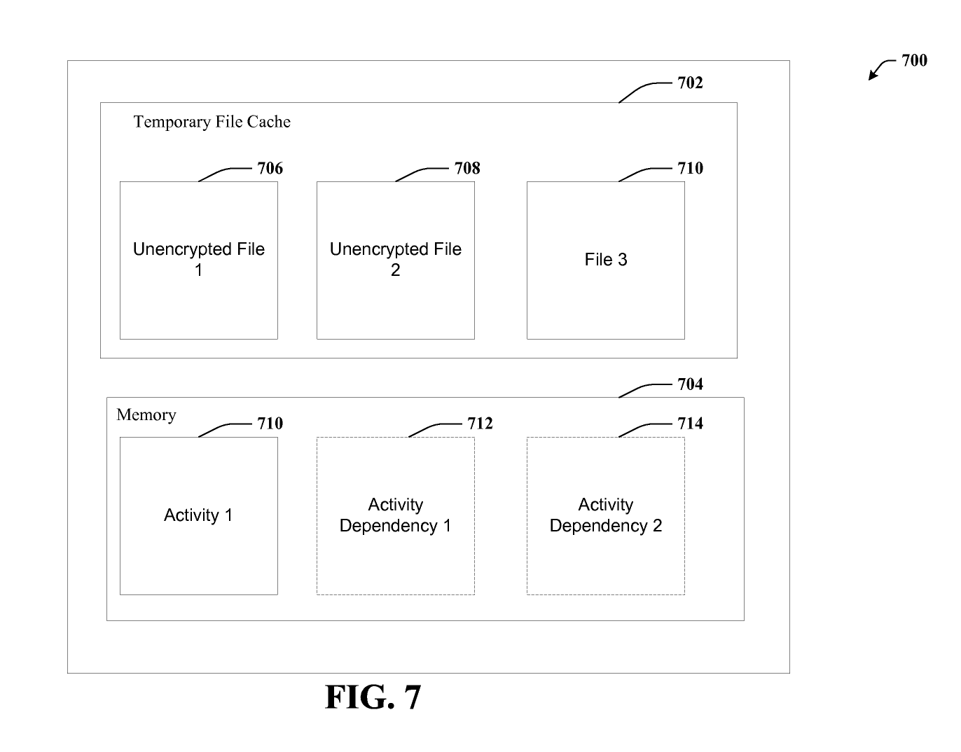

Turning to FIG. 7, the storage 700 of a computer executing the presentation application is illustrated according to one aspect. In particular, the temporary file cache 702 and the memory 704 are illustrated. As stated supra, in some embodiments activities are executed one at a time and unloaded after execution. Therefore, when an activity is to be loaded to be executed, files (706, 708, 710) can be decrypted and/or decompressed and stored temporarily in a temporary file cache 702. Advantageously, streams in a library can be read directly from the package (e.g., via an API) during activity execution and hence an unencrypted version is not stored temporarily on the student's computer. Thus, streams can be more secure for content subject to digital rights management.

In addition to file decompression/decryption, the activity 710 being executed, activity dependencies (e.g., dynamic link libraries, API libraries, etc.) (712, 714), if any, are loaded into the memory. Other activities are not loaded and thus a student may not cheat if, for example, the current activity is an assessment by also running an activity that teaches the subject matter being assessed.

Security is also advantageously enhanced by loading a single activity into memory and unloading it before loading another activity. For example, since an activity loads libraries associated with an activity, other content (e.g, in other libraries) that is not associated with the activity can be inaccessible (e.g., encrypted so it cannot be copied). In addition, cross-activity security attacks are prevented. Furthermore, resources (e.g, memory, disk space) needed to present the activities are reduced as well. Advantageously, this facilitates uses on resource-constrained computers, such as mobile devices or older computer in an educational institution's computer lab.

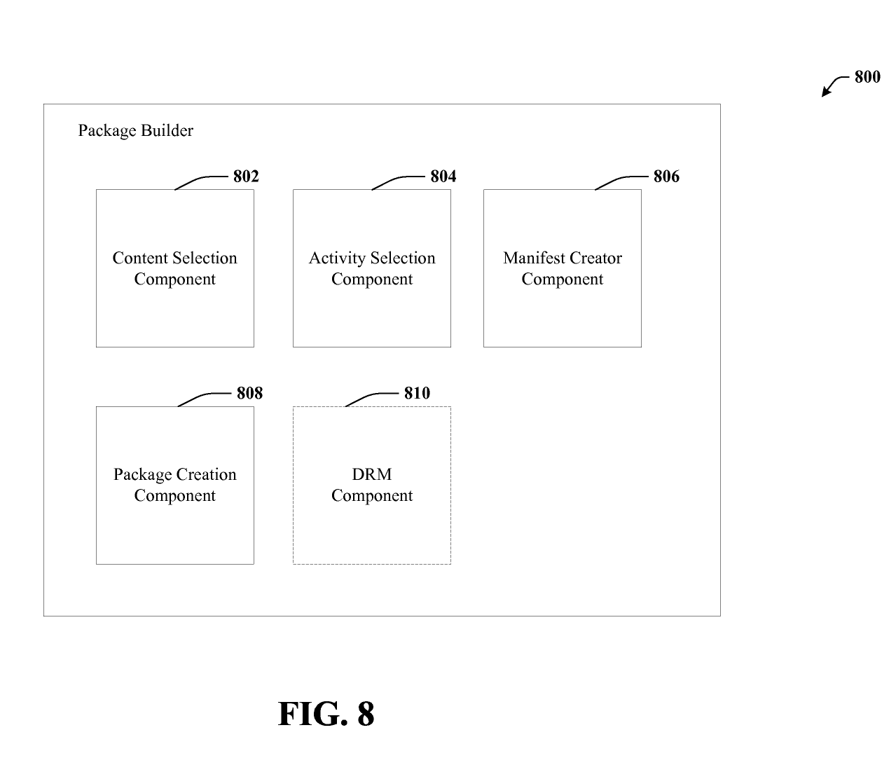

Turning to FIG. 8, the components of a package builder application 800 according to one embodiment are illustrated. A content selection component 802 receives an indication of educational content to include in a package. The content can be currently organized into a library or the content selection component 802 can package indicated content into a library. The indication can be received via a graphical user interface. The activity selection component 804 receives an indication of one or more activities to include in a package. The manifest creator component 806 receives an indication of information for the manifest file and automatically generates the manifest. The DRM component 810 encrypts educational content in one or more libraries and generates a license file to include in the package. For example, the educational content can be encrypted using PKI. After the manifest is generated, the package creation component places the activities, the libraries, the manifest, and license file, if any, in an archival file format. The package creation component 808 can also compress the file, such as compressing using the ZIP standard.

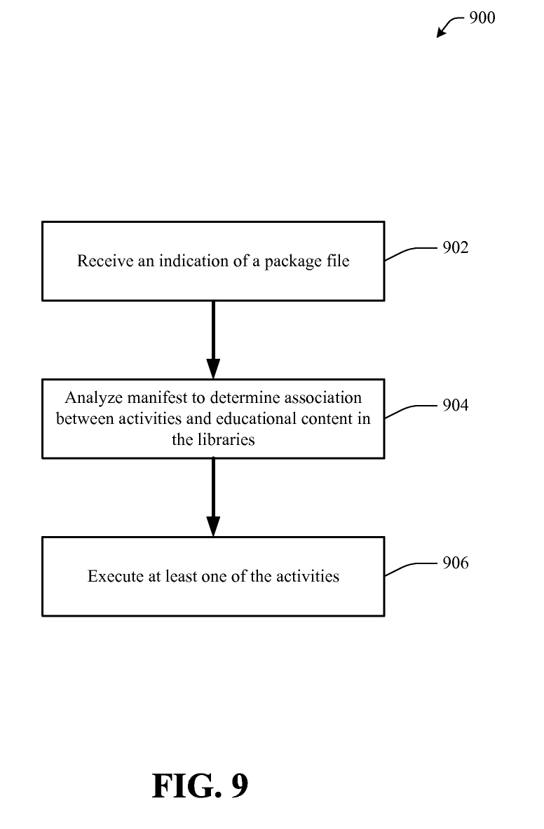

In view of the exemplary systems described supra, methodologies that can be implemented in accordance with the disclosed subject matter will be better appreciated with reference to the flowcharts of FIGS. 9-11. While for purposes of simplicity of explanation, the methodologies are shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be appreciated that various other branches, flow paths, and orders of the blocks, can be implemented which achieve the same or a similar result. Moreover, not all illustrated blocks can be required to implement the methodologies described hereinafter.

Referring to FIG. 9, a method 900 of the educational presentation system is illustrated according to one embodiment. At 902, an indication is received of a package file. For example, the user may have doubled clicked on the package file or selected it from an open file dialog box. At 904, the manifest file is analyzed to determine associations between activities and education content in the libraries. Additional information can also be analyzed from the manifest file, such as the order of the activities, security policies, etc. At 906, at least one of the activities is executed.

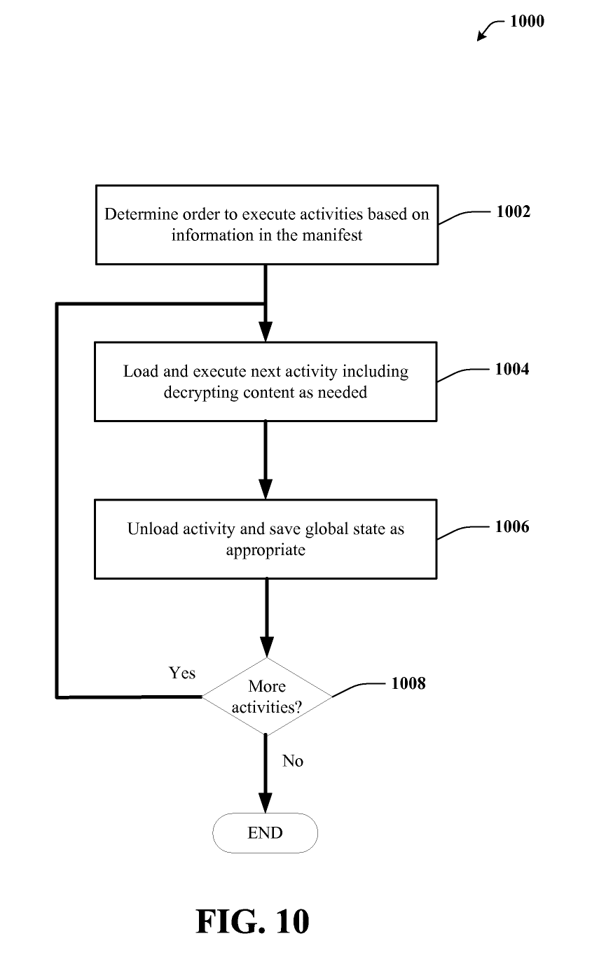

FIG. 10 illustrates a method 1000 of executing activities by the educational presentation system according to one embodiment. For example, this method can be executed at 906 of FIG. 9. At 1002, the order of activities is determined based on information in the manifest, as well as potentially other information (e.g., an initial assessment of the learner), At 1004, the next activity (or initially the first activity) is loaded and executed. During 1004, educational content that is encrypted can be decrypted and used in accordance with the digital rights (e.g., specified in the license) or security policies (e.g., as specified in the manifest). After executing the activity, the activity is unloaded at 1006 and any global state (e.g., last activity performed, assessment scores, etc.) is saved as appropriate. At 1008, the method determines if there are more activities to execute. If so, the method returns to 1004 to load and execute the next activity. Otherwise, if it is determined that there are no more activities to execute, execution of the activities can end.

Although not shown, one will appreciate that one or more activities in the package file cannot be executed. For example, if activities are associated with a type of learning (e.g., auditory, written, hands-on), activities that are not associated with a current learner's learning style may not be executed for that learner.

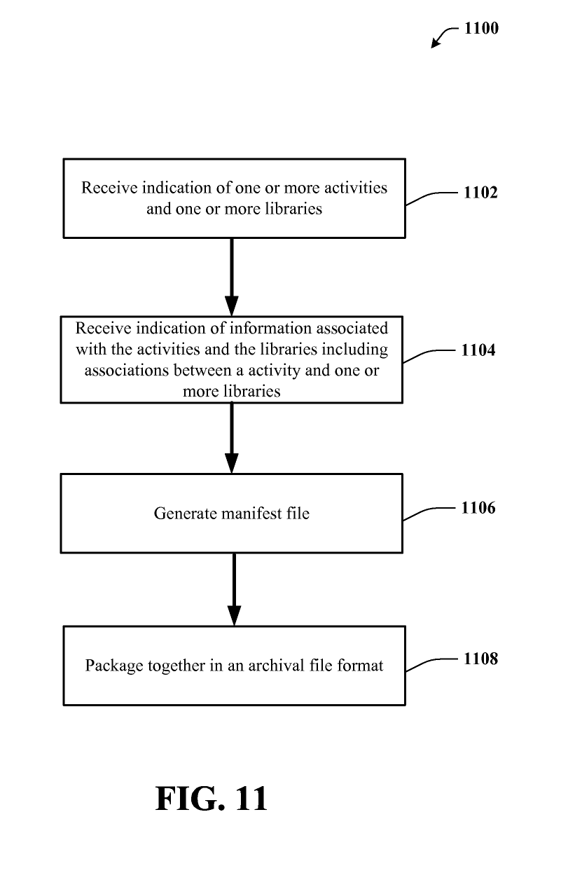

FIG. 11 illustrates a method 1100 of creating of an archival file to facilitate learning according to one embodiment. At 1102, an indication is received of one or more activities and one or more libraries. This indication can be received interactively, such as via a plug-in in a content creation tool (e.g., a word-processing program, a video editing program, etc.) or a graphical user interface of the publisher application, or can be received in a non-interactive manner, such as via an XML file. At 1104, an indication is received of information associated with the activities and libraries including associations between activities and libraries. The information can, for example, also be received interactively, such as via a graphical user interface of the package builder application. At 1106, a manifest file can be automatically generated based on the previously received indication. However, in other embodiments, the manifest file can be manually created, such as in a text editor. At 1108, the indicated activities and libraries, along with the manifest file are packaged into the described file format. As part of the packaging, some or all of the educational content and activities can be encrypted using a PKI to facilitate security and digital rights management.

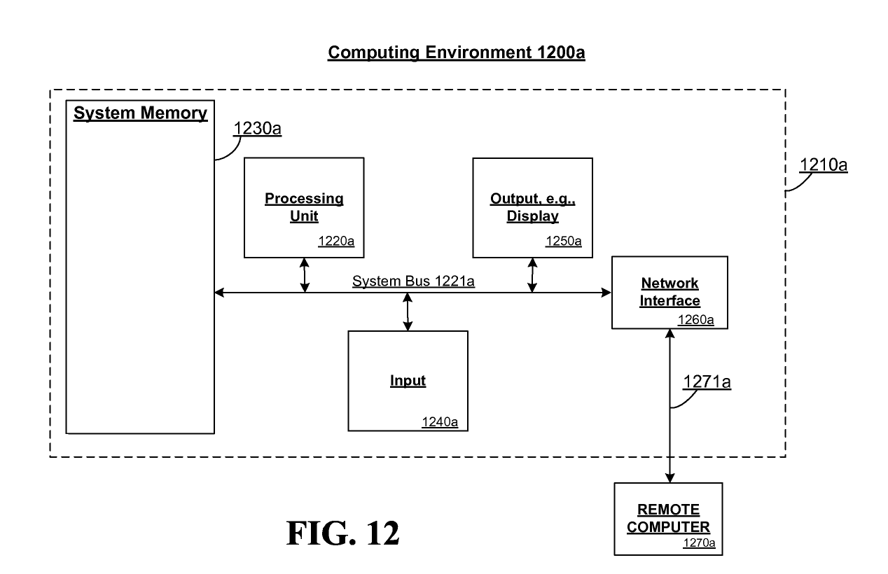

As mentioned, the invention applies to any device wherein it can be desirable to facilitate learning. It should be understood, therefore, that handheld, portable and other computing devices and computing objects of all kinds are contemplated for use in connection with the present invention, i.e., anywhere that a device can present educational content. Accordingly, the below general purpose computer described below in FIG. 12 is but one example.

Software can be described in the general context of computer-executable instructions, such as program modules, being executed by one or more computers. Those skilled in the art will appreciate that the invention can be practiced with other computer system configurations and protocols.

FIG. 12 thus illustrates an example of a suitable computing system environment 1200a in which the invention can be implemented, although as made clear above, the computing system environment 1200a is only one example of a suitable computing environment for a media device and is not intended to suggest any limitation as to the scope of use or functionality of the invention. Neither should the computing environment 1200a be interpreted as having any dependency or requirement relating to any one or combination of components illustrated in the exemplary operating environment 1200a.

With reference to FIG. 12, an exemplary remote device for implementing the invention includes a general-purpose computing device in the form of a computer 1210a. Components of computer 1210a can include, but are not limited to, a processing unit 1220a, a system memory 1230a, and a system bus 1221a that couples various system components including the system memory to the processing unit 1220a. The system bus 1221a can be any of several types of bus structures including a memory bus or memory controller, a peripheral bus, and a local bus using any of a variety of bus architectures.

Computer 1210a typically includes a variety of computer readable media. Computer readable media can be any available media that can be accessed by computer 1210a. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1210a. Communication media typically embodies computer readable instructions, data structures, program modules or other data in a modulated data signal such as a carrier wave or other transport mechanism and includes any information delivery media.

The system memory 1230a can include computer storage media in the form of volatile and/or nonvolatile memory such as read only memory (ROM) and/or random access memory (RAM). A basic input/output system (BIOS), containing the basic routines that help to transfer information between elements within computer 1210a, such as during start-up, can be stored in memory 1230a. Memory 1230a typically also contains data and/or program modules that are immediately accessible to and/or presently being operated on by processing unit 1220a. By way of example, and not limitation, memory 1230a can also include an operating system, application programs, other program modules, and program data.

The computer 1210a can also include other removable/non-removable, volatile/nonvolatile computer storage media. For example, computer 1210a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1221a through a non-removable memory interface such as an interface, and a magnetic disk drive or optical disk drive is typically connected to the system bus 1221a by a removable memory interface, such as an interface.

A user can enter commands and information into the computer 1210a through input devices such as a keyboard and pointing device, commonly referred to as a mouse, trackball or touch pad. Other input devices can include a microphone, joystick, game pad, satellite dish, scanner, or the like. These and other input devices are often connected to the processing unit 1220a through user input 1240a and associated interface(s) that are coupled to the system bus 1221a, but can be connected by other interface and bus structures, such as a parallel port, game port or a universal serial bus (USB). A graphics subsystem can also be connected to the system bus 1221a. A monitor or other type of display device is also connected to the system bus 1221a via an interface, such as output interface 1250a, which can in turn communicate with video memory. In addition to a monitor, computers can also include other peripheral output devices such as speakers and a printer, which can be connected through output interface 1250a.

The computer 1210a can operate in a networked or distributed environment using logical connections to one or more other remote computers, such as remote computer 1270a, which can in turn have media capabilities different from device 1210a. The remote computer 1270a can be a personal computer, a server, a router, a network PC, a peer device or other common network node, or any other remote media consumption or transmission device, and can include any or all of the elements described above relative to the computer 1210a. The logical connections depicted in FIG. 12 include a network 1271a, such local area network (LAN) or a wide area network (WAN), but can also include other networks/buses. Such networking environments are commonplace in homes, offices, enterprise-wide computer networks, intranets and the Internet.

When used in a LAN networking environment, the computer 1210a is connected to the LAN 1271a through a network interface or adapter. When used in a WAN networking environment, the computer 1210a typically includes a communications component, such as a modem, or other means for establishing communications over the WAN, such as the Internet. A communications component, such as a modem, which can be internal or external, can be connected to the system bus 1221a via the user input interface of input 1240a, or other appropriate mechanism. In a networked environment, program modules depicted relative to the computer 1210a, or portions thereof, can be stored in a remote memory storage device. It will be appreciated that the network connections shown and described are exemplary and other means of establishing a communications link between the computers can be used.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts can be applied to any computing device or system in which it is desirable to facilitate student learning. For instance, in other embodiments, additional hardware or software components can transform some or all of the educational content to facilitate learning by students with disabilities. For example, text-to-speech can be used to present text to a visually impaired student or a student with dyslexia.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. One or more components can reside within a process and/or thread of execution and a component can be localized on one computer and/or distributed between two or more computers.

Thus, the methods and apparatus of the present invention, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

The methods and data structures of the present invention can also be practiced via communications embodied in the form of program code or content that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention can invariably be a combination of hardware and software.

Furthermore, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

As will be appreciated various portions of the disclosed systems above can include or comprise artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments can be used or modifications and additions can be made to the described embodiment for performing the same function of the present invention without deviating therefrom. For example, the methods, as described in the present application can apply to any computing device or environment, such as a gaming console, handheld computer, portable computer, etc. Furthermore, it should be emphasized that a variety of computer platforms, including handheld device operating systems and other application specific operating systems are contemplated.

While exemplary embodiments refer to utilizing the present invention in the context of particular programming language environments (e.g., the Common Language Runtime, Java virtual machine), the invention is not so limited, but rather can be implemented in any programming language environment that provides a facility (e.g., API, macros, etc.) that facilitate the separation of content from behavior. Still further, the present invention can be implemented in or across a plurality of processing chips or devices, and memory can similarly be effected across a plurality of devices. Therefore, the present invention should not be limited to any single embodiment, but rather should be construed in breadth and scope in accordance with the appended claims.

What is claimed is:

1. A computer-readable storage medium for facilitating learning comprising:
one or more assemblies, each assembly comprises a set of instructions for performing one or more behaviors without installation;
one or more libraries each comprising educational content; and
a manifest file that describes associations between each of at least some of the one or more assemblies and one or more libraries such that the execution of an assembly presents at least some of the educational content in the associated one or more libraries.

2. The computer-readable storage medium of claim 1 wherein at least one of the one or more libraries comprises encrypted content and further comprising a license that facilitates authorized use of the encrypted content.

3. The computer-readable storage medium of claim 1 wherein at least one of the one or more libraries comprises one or more media streams.

4. The computer-readable storage medium of claim 1 wherein at least one of the assemblies is associated with two or more libraries.

5. The computer-readable storage medium of claim 1 wherein at least one of the libraries is associated with at least two assemblies.

6. The computer-readable storage medium of claim 1 wherein at least one of the one or more assemblies is developed by a third-party developer.

7. The computer-readable storage medium of claim 1 wherein the manifest file, assemblies and the one or more libraries are contained within a compressed archival file format.

8. The computer-readable storage medium of claim 1 wherein each assembly comprises a set of instructions in at least one of common language runtime bytecodes or Java bytecodes.

9. The computer-readable storage medium of claim 1 wherein the behavior of at least one assembly comprises learning assessment.

10. A method of facilitating computer-based learning, the method comprising:
receiving an indication of a file in an archival file format, the archive file comprising a manifest, one or more activities and one or more libraries of educational content;
analyzing the manifest, the analyzing comprising determining an association between each of one or more activities and the one or more libraries of educational content; and
executing at least one of the one or more activities, the execution presenting educational content from the one or more associated libraries.

11. The method of claim 10 wherein the analyzing of the manifest comprises determining an order to execute one or more activities and the executing of at least one of the one or more activities comprises executing the one or more activities in the determined order.

12. The method of claim 11 wherein the determining of an order to execute one or more activities comprises determining a non-linear order.

13. The method of claim 10 wherein at least one library comprises one or more files and one or more streams.

14. The method of claim 10 wherein the executing of at least one of the one or more activities comprises executing each activity one at a time.

15. The method of claim 10 wherein at least one of the one or more libraries comprises one or more encrypted files and one or more encrypted streams and the presenting of at least some educational content comprises decrypting the educational content.

16. The method of claim 15 wherein the presenting of educational content comprises presenting educational content in the one or more encrypted streams without saving the unencrypted stream to memory.

17. The method of claim 10 wherein the executing of at least one of the one or more activities comprises executing at least one of a Common Language Runtime assembly or a Java archive.

18. A educational presentation system comprising:
a memory;
means for analyzing a manifest in a compressed archival file format, the compressed file comprising one or more behaviors and one or more libraries of educational content, each library having one or more files comprising educational content, the analyzing comprising associating one or more libraries with each of one or more behaviors;
means for digital right management of the educational content in at least one of the one or more libraries; and
means for executing one or more behaviors one at a time to facilitate learning, the executing comprising presenting the associated education content.

19. The educational presentation system of claim 18 wherein the means for executing one or more behaviors executes at least one of the behaviors without installation of the behavior.

20. The educational presentation system of claim 18 wherein the means for analyzing a manifest determines a non-linear order of execution of one or more behaviors and the means for executing one or more behaviors executes the one or more behaviors in accordance with the determined order.
